(19) United States
(12) Patent Application Publication
(10) Pub. No.: US 2013/0274020 A1
(43) Pub. Date: Oct. 17, 2013

(54) COMPUTING PLATFORM FOR SUPPORTING MASSIVELY MULTI-PLAYER ONLINE GAMES

(71) Applicant: METEOR ENTERTAINMENT, INC., Seattle, WA (US)

(72) Inventors: Sarah Novotny, Seattle, WA (US); Nicholas Herring, Seattle, WA (US); Cyrus Durgin, Seattle, WA (US)

(73) Assignee: METEOR ENTERTAINMENT, INC., Seattle, WA (US)

(21) Appl. No.: 13/797,868

(22) Filed: Mar. 12, 2013

Related U.S. Application Data
(60) Provisional application No. 61/622,740, filed on Apr. 11, 2012.
(60) Provisional application No. 61/718,686, filed on Oct. 25, 2012.

(51) Int. Cl. G06F 17/30

(52) U.S. Cl. CPC G06F 17/30283
USPC 463/42

(57) ABSTRACT

A computing platform, system, and method for providing a massively multi-player online game (MMO, MMOG) is described. In some implementations, the platform provides an abstraction layer between client devices associated with players of a game and computing resources, such as cloud-based resources, that support and provide the game to the players.

### CROSS REFERENCE TO RELATED APPLICATIONS

This application is related to, and claims the benefit of, U.S. Provisional Patent Application No. 61/622,740, titled CLOUD-BASED GAMING PLATFORM (filed Apr. 11, 2012), and U.S. Provisional Patent Application No. 61/718,686, titled MODIFYING USE OF RESOURCES WITHIN A CLOUD-BASED GAMING PLATFORM (filed Oct. 25, 2012), each of which is herein incorporated by reference in its entirety. This application is related to U.S. Pat. No. ______, titled MODIFYING USE OF RESOURCES WITHIN A CLOUD-BASED GAMING PLATFORM (filed Mar. 12, 2013, Attorney Docket No. 876908002US), and U.S. Pat. No. ______, titled A COMPUTING PLATFORM FOR SUPPORTING MASSIVELY MULTI-PLAYER ONLINE GAMES (filed Mar. 12, 2013, Attorney Docket No. 876908004US), each of which is herein incorporated by reference in its entirety. To the extent that the foregoing applications and/or any other materials herein incorporated by reference conflict with the present disclosure, the present disclosure controls.

### BACKGROUND

A massively multi-player online game (MMO or MMOG) is a multiplayer video game capable of supporting hundreds, thousands, or millions of simultaneous players. A MMO may be, for example, a role playing game, a first person shooter game, a real-time or turn-based strategy game, a simulation game, a sports game, a casual game, and so on. Game publishers provide a gaming environment via the Internet or other public or private networks, enabling players at personal computers, mobile devices, game consoles, and other client devices to have access to the game.

The emergence of free-to-play (F2P) online games has changed the monetization paradigm for video games from sales of a product (the game itself) to one of micro-transactions within a game. These in-game purchases may directly impact game balance and game server security, among other things. In fact, many gamers worry that F2P games are in fact P2W (pay-to-win) games, and are often reluctant to play newly introduced games. For example, gamers who believe that a game is P2W are unlikely to continue playing the game, and even less likely to make in-game purchases themselves. Losing gamers that would normally spend money within a game introduces many problems in to the F2P model of gaming. Without a consistent player:revenue ratio in the F2P model, losses are borne by dedicated, long-term, and/or high-spending players, by the game publisher, or by all parties involved. Additionally, a F2P game should facilitate gamers who do not spend money to play the game, without adversely impacting the other players within the game.

Typically, a MMO is supported by game servers that communicate directly with client devices to provide game play and various third party services to players during the game play. FIG. 1 depicts a conventional computing environment 100 for a MMO. The conventional computing environment 100 includes one or more game servers 110 that host and support game play for the MMO, and communicate with client devices 120 associated with players of the MMO. Typically, the game servers 110 are hardware based servers controlled and/or operated by the provider of the MMO, such as a game publisher. In addition to game play, the conventional computing environment 100 may also provide 3^{rd} party services 115, such as player communication components (e.g., VoIP), game servers 110, store components (e.g., in game stores), and so on, directly via the game servers 110.

Utilizing game provider controlled hardware devices to provide the game play, as well as directly providing 3^{rd} services via such hardware devices, may lead to various problems and drawbacks associated with providing engaging, entertaining gaming experiences to players of a massively multi-player online game. For example, the game provider may find scalability of the game to be difficult and/or cost inefficient, may encounter issues with providing updated and seamless 3^{rd} party services within a game, among other drawbacks.

Therefore, the need exists for a computing environment and system that overcomes the above problems associated with providing massively multiplayer online games, as well as one that provides additional benefits and features.

### BRIEF DESCRIPTION OF THE FIGURES

FIG. 1 is a block diagram illustrating components of a conventional gaming environment.

FIGS. 2A-2B are block diagrams illustrating a cloud-based computing platform that supports massively multi-player online games.

FIG. 3A is a block diagram illustrating components of a platform manager module.

FIG. 3B is a block diagram illustrating components of a decision engine module.

FIG. 4 is a flow diagram illustrating a routine for providing an online game using cloud-based computing resources.

FIG. 5 is a flow diagram illustrating a routine for managing computing resources that support an online game based on information received from a matchmaker service associated with the online game.

FIG. 6 is a flow diagram illustrating a routine for managing computing resources that support an online game based on information received from a matchmaker service associated with the online game and information associated with play of the online game.

FIG. 7 is a flow diagram illustrating a routine for managing computing resources that support an online game based game play characteristics for the online game.

FIG. 8 is a flow diagram illustrating a routine for re-provisioning computing resources that support an online game based on information received from current play within the online game.

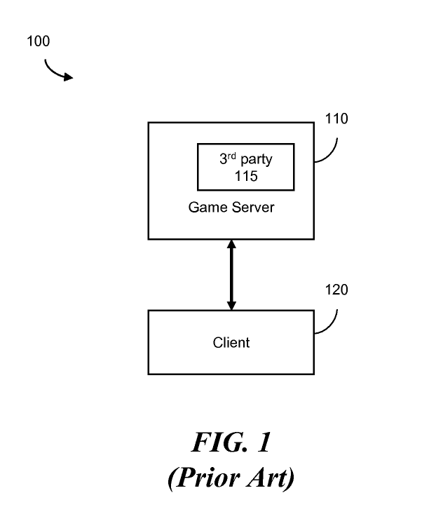

### DETAILED DESCRIPTION

### Overview

A computing platform for providing and/or supporting an online video game, such as a massively multi-player online game (MMO, MMG, MMOG, MMORPG, and so on), is described. The computing platform, in some implementations, is a multi-tenant video game publishing platform designed to reduce complexity in the publishing and operation of online games, as well as deliver various levels of telematic-based modifications, among other things. The computing platform may utilize on-demand computing power from multiple public cloud services vendors (e.g., Amazon's AWS, the Rackspace cloud, Microsoft's Azure, and so on), as well as locally or privately provided cloud services, to provide a scalable, affordable and/or high performance gaming environment, among other benefits. Additionally or alternatively, in some implementations, the computing platform utilizes network performance and geo-location data to optimize game play for a supported MMO.

The computing platform may support various systems and methods utilizing some or all of the features described herein, such as systems and methods that provide a layer of abstraction within a cloud-based gaming platform. For example, in some implementations, the computing platform includes a platform manager module that includes a request component configured to receive requests to access the MMO from client devices associated with players of the MMO, a provisioning component configured to provision one or more cloud-based game instances that provide the MMO to the client devices, and a connection component configured to facilitate direct connections between the client devices and the provisioned cloud-based game instances that provide the MMO.

The computing platform, and associated systems and methods will now be described with respect to various embodiments, examples, and/or implementations. The following description provides specific details for a thorough understanding of, and enabling description for, these embodiments of the platform. However, one skilled in the art will understand that the platform and associated systems and methods may be practiced without these details. In other instances, well-known structures and functions have not been shown or described in detail to avoid unnecessarily obscuring the description of the embodiments of the platform.

The terminology used in the description presented below is intended to be interpreted in its broadest reasonable manner, even though it is being used in conjunction with a detailed description of certain specific embodiments of the platform. Certain terms may even be emphasized below; however, any terminology intended to be interpreted in any restricted manner will be overtly and specifically defined as such in this Detailed Description section.

### The MMO Computing Platform

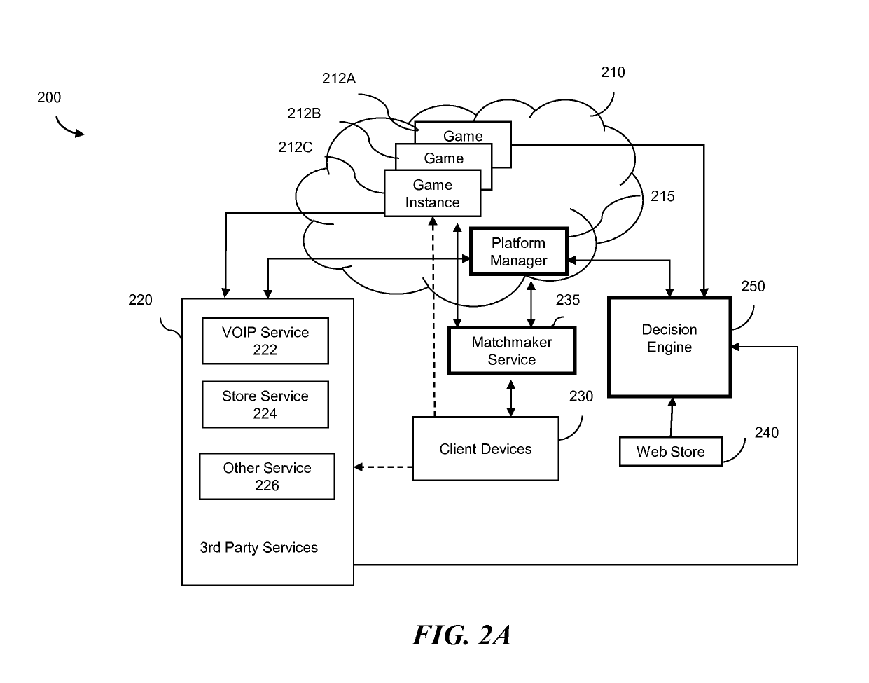

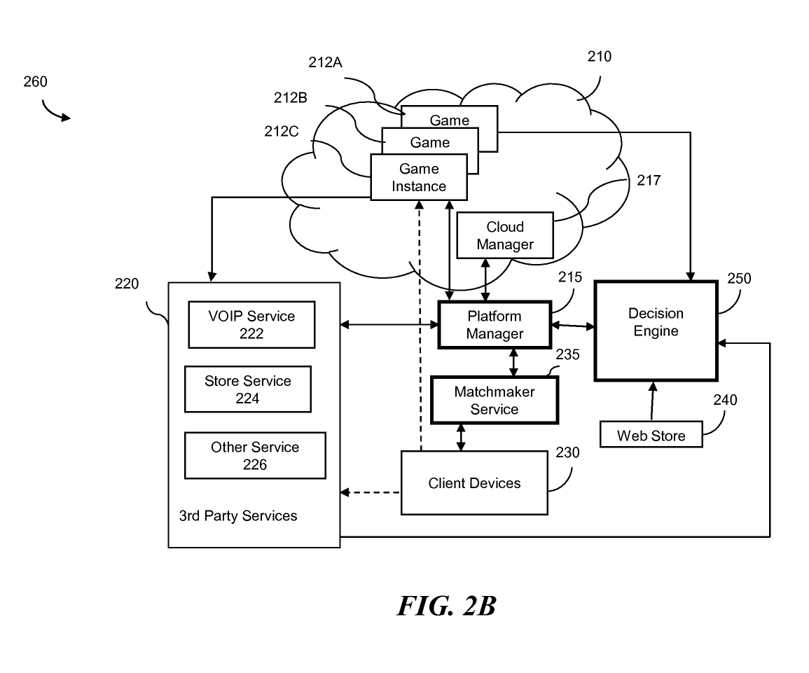

A computing platform that establishes and/or provides a cloud-based, scalable, computing environment in which to support a massively multi-player online game to many users or players located at client devices is described. FIG. 2A depicts various components of such a cloud-based computing platform 200.

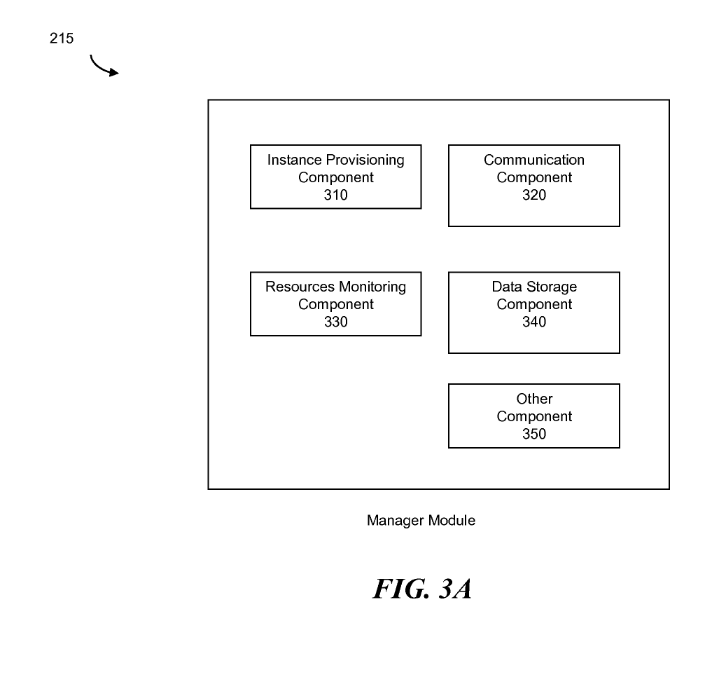

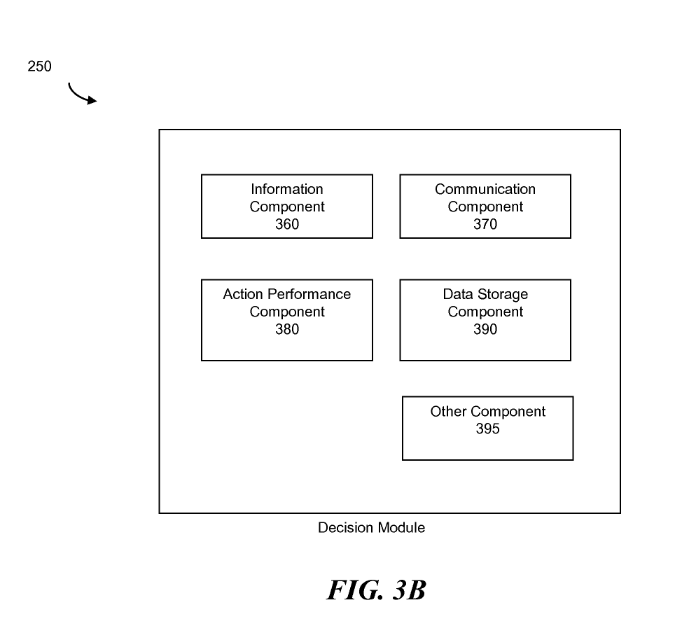

FIGS. 2A-3B and the following discussion provide a brief, general description of a suitable computing environment in which the MMO computing platform and various associated systems and methods can be implemented. Although not required, aspects of the platform are described in the general context of computer-executable instructions, such as routines executed by a general-purpose computer, e.g., a server computer, wireless device, game console, and/or personal computer. Those skilled in the relevant art will appreciate that the system can be practiced with other communications, data processing, or computer system configurations, including: Internet appliances, network PCs, mini-computers, mainframe computers, cloud-based computers, virtual machines, and the like. Indeed, the terms “computer,” “host,” and “host computer” are generally used interchangeably herein, and refer to any of the above devices and systems, as well as any data processor.

Aspects of the computing platform can be embodied in a special purpose computer or data processor that is specifically programmed, configured, or constructed to perform one or more of the computer-executable instructions explained in detail herein. Aspects of the computing platform can also be practiced in distributed computing environments where tasks or modules are performed by remote processing devices, which are linked through a communications network, such as a Local Area Network (LAN), Wide Area Network (WAN), Storage Area Network (SAN), Fibre Channel, or the Internet. In a distributed computing environment, program modules may be located in both local and remote memory storage devices.

Aspects of the computing platform may be stored or distributed on computer-readable media, such as computer-readable storage media, tangible computer-readable media, and/or tangible computer-readable storage media, including magnetically or optically readable computer discs, hard-wired or preprogrammed chips (e.g., EEPROM semiconductor chips), nanotechnology memory, biological memory, or other tangible data storage media. Non-transitory computer-readable media include tangible media such as hard drives, CD-ROMs, DVD-ROMS, and memories such as ROM, RAM, and Compact Flash memories that can store instructions and other storage media. Signals on a carrier wave such as an optical or electrical carrier wave are examples of transitory computer-readable media. Moreover, the computing platform may include computing resources typical of an “Infrastructure as a Service” (IaaS) model, such as resources providing cloud-based virtual machines, servers, storage, load balancing, network architectures, and so on, computing resources typical of a “Platform as a Service” (PaaS) model, such as resources providing run-time computing, databases, web servers, development tools, and so on, and/or computing resources typical of a “Software as a Service” (SaaS) model, such as resources providing CRM, communications, virtual desktops, games, and so on, among other resources. Indeed, computer implemented instructions, data structures, screen displays, and other data under aspects of the computing platform may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the computing platform reside on a server computer, while corresponding portions reside on a client computer, and thus, while certain hardware platforms are described herein, aspects of the system are equally applicable to nodes on a network.

Referring back to FIG. 2A, the computing platform 200 utilizes a cloud-based services computing environment 210 that provisions, establishes, and/or supports one or more game instances 212A-C, each providing a massively multi-player online game and/or various aspects of the MMO. The cloud-based computing environment 210 includes computing resources that facilitate provisioning of the game instances 212A-C to a heterogeneous group of client devices 230 associated with players of the MMO.

For example, the cloud-based computing environment 210 may include computing resources typical of an IaaS model, such as resources providing cloud-based virtual machines, servers, storage, load balancing, network architectures, and so on, computing resources typical of a PaaS model, such as resources providing run-time computing, databases, web servers, development tools, and so on, and/or computing resources typical of an SaaS model, such as resources providing CRM, communications, virtual desktops, games, and so on, among other resources.

The cloud-based computing environment 210 may be formed of a variety of different cloud environments, including a public cloud, a community cloud, a hybrid cloud, a private cloud, an “intercloud,” or any other computing environment capable of and configured to provide infrastructure resources, platform resources, and/or software resources as a service to client devices located within a shared network, among other things.

The game instances 212A-C provide the MMO to client devices 230, such as laptops, smart phones, tablet computers, and so on, associated with players of the MMO, which directly connect and communicate with the instances 212A-C in order to play the game. The client devices 230 may access the game instances 212A-C in a variety of ways, such as via device supported web browsers, game specific software (such as apps downloaded to a device), game console software (such as software running on a PSP, PLAYSTATION, XBOX, NINTENDO, etc.) and so on. Thus, in some implementations, users of the client devices 230 directly connect with the game instances 212A-C within the cloud-based computing environment 210 in order to play a game, such as an MMO, that is provided by the game instances 212A-C.

The computing platform 200, in some implementations, also facilitates direct connections between the client devices 230 and services provided by 3^{rd} parties, or 3^{rd} party services 220, within a game. The platform 200 enables client devices to directly access a communication service 222, a store service 224, or other such services 226 associated with a game while playing the game. For example, the computing platform 200 facilitates a player at the client device 230 to access and communicate with other players via a VoIP service 222 while playing a game, without directly providing the VoIP service 222 to the player at the client device 230.

That is, the computing platform 200, in some implementations, provides various uniform APIs to developers of 3^{rd} party services 220 that enable the developers to access a game supported by the game instances 212A-C and provide various services to players at client devices 230. The computing platform 200 facilitates 3^{rd} party vendors to provide various services, such as communication services 222 (e.g., voice, text, chat, and so on), financial services 224 (e.g., storefronts, virtual catalogs, payment facilities, and so on) to players of a game without requiring any direct implementation of such services within the game itself. The computing platform 200 or 260 abstracts the access to game associated services to players at client devices 230 while providing the service providers a flexibility in access, implementation, and/or modification of the services they are providing to players of the game.

Thus, in some implementations, the computing platform 200 or 260 provides a uniform set of APIs to game developers for common components, including economy and item management, game and infrastructure analytics, voice and text communication, and/or matchmaking services. Thus, the game developer is freed from the burden of developing these services themselves, and/or integrating with heterogeneous third-party providers, among other benefits.

Many of the systems and methods described herein are provided by and/or performed by a platform manager module 215, which may be located in the cloud computing environment 210, or elsewhere within the computing platform (see FIG. 2B). The platform manager module 215, in some implementations, facilitates the scaling of the computing platform 200, including the addition and/or removal of game instances 212A-C based on a dynamic view of a gaming environment provided by the game instances 212A-C, among other things.

In some implementations, the platform manager module 215 receives information from a matchmaker service 235, such as a matchmaker service provided by the game publisher, and performs actions based on the received information. A matchmaker service 235 is, among other things, a component within the computing platform 200, often provided by a game publisher, that determines what users to bring together when creating or expanding a game being offered. For example, the matchmaker service 235 may receive a request from a user to join a specific MMO currently being played, identify a suitable point of entry for the user into the game based on information about the user (e.g., the user's location, skill level, historical game play, and so on), and match the user to other users within the currently playing MMO. The platform manager module 215, in some implementations, communicates with the matchmaker service 235 in order to obtain such information and perform various actions, such as actions associated with scaling a game, actions associated with modifying resources supporting the game, and so on. Further details regarding the interactions between the platform manager module 215, including interactions between the matchmaker service 235 and the platform manager module 215, are provided herein.

In some implementations, the platform manager module 215 receives information from a decision engine 250, such as a data driven decision module that is programmed and/or configured to track, obtain, analyze, and make decisions regarding some or all aspects of game supported by the game instances 212A-C, such as information from an associated web store 240, among other things. The platform manager module 215 may then perform actions based on the data provided by the decision engine 250, such as actions associated with adding or removing game instances 212A-C during game play, among other things. Further details regarding the decision engine 250, including interactions between the platform manager module 215 and decision engine 250, are provided herein.

As described herein, in some implementations, the platform manager module 215 may be located outside of the cloud-based computing environment 210, such as at a location associated with or physically proximate to a game publisher that utilized the computing platform described herein to provide an online game. FIG. 2B depicts a computing platform 260 that includes the platform manager module 215 located outside of the cloud-based computing environment 210. The platform manager module 215 may interact with computing resources within the cloud-based computing environment via a cloud manager module 217, which facilitates communications between the platform manager module 215 and various cloud-based and/or cloud supported resources, such as the game instances 212A-C.

The computing platforms 200 and/or 260 facilitate many different flows of data or other information between components, as shown by the arrows in the Figures. For example, in some implementations:

+ game play data (e.g., play instructions) may flow from client devices 230 to game instances 212A-C and/or to 3^{rd} party services;

+ information generated within the game instances 212A-C may flow to the decision engine 250, the 3^{rd} party services 220, the platform manager module 215, or elsewhere;

+ information generated by the 3^{rd} party services 220, the web store 240, the platform manager 215, the game instances 212A-C, or elsewhere, may flow to the decision engine 250;

+ information may flow from the platform manager module 215 to the decision engine 250, and from the decision engine 250 to the platform manager module 215;

+ information may flow between the platform manager module 215 and the 3^{rd} party services 220; and/or

+ information may flow between the matchmaker service 235 and the client devices 230, between the matchmaker service 235 and the platform manager module 215, and/or between the matchmaker service 235 and the game instances 212A-C; and so on.

Of course, one of ordinary skill in the art will realize that the computing platform 200 may facilitate the flow of information and/or data between other components and/or resources not specifically described herein.

The computing platform 200 or 260 may provide publically available services wrapped with a web services API. Such services may be accessed from a client or server, as well as any web properties surrounding a game. In some cases, the platform is resource-oriented, with each service responsible for managing its own persistence layer. For example, the services may expose an API accessible by any HTTPS client. Clients and servers mutually authenticate each other, when necessary, using industry standard SSL certificates. In some cases, clients and servers communicate using both the HTTP layer protocol (headers, and so on) and the entity body (request/response payload). Entity bodies may be JSON-encoded, and adhere to a common format across services. That is, services requests may be simple HTTP requests, where a HTTP verb dictates the type of operation being performed upon a specified resource. For example, any method-specific additional parameters may be included as query string parameters concatenated to a request URL.

As described herein, the platform manager module 215 may act as a layer of abstraction between the resources providing game play (e.g., game instances 212A-C) and client devices that enable users to play a game. The platform manager module 215, in some implementations, includes various components configured and/or programmed to facilitate the performance of various actions within the computing platform 200.

FIG. 3A depicts components of the platform manager module 215. In some implementations, the platform manager module 215 includes an instance provisioning component 310 configured and/or programmed to perform actions that cause the cloud-based computing environment 210 to add, remove, and/or otherwise modify the number, amount, and/or provisioning of cloud-based game servers, such as game instances 212A-C, utilized to provide a game to client devices 230. For example, the instance provisioning component 310 may provide instructions to the cloud-based computing environment 210 to launch and provision an additional game instance 212C when game play information identifies a need for additional supporting resources.

In some implementations, the platform manager module 215 includes a communication component 320 configured and/or programmed to facilitate communication between the platform manager module 215 and other components within the computing platform 200 or 260.

In some implementations, the platform manager module 215 includes a resources monitoring component 330 configured and/or programmed to track and/or monitor the operation of some or all of the resources within the computing platform 200 or 260. For example, the resources monitoring component 330 may monitor game play statistics associated with game instances 212A-C, may monitor users associated with a matchmaker service 235, and/or perform other telematics within the computing platform 200 or 260. The platform manager module 215 may also include a data storage component 340, such as various databases and/or memory, that store data associated with game play, computing platform resources and/or components, performed actions, data analyses, and so on.

The platform manager module 215 may also include other components 350, such as components that perform various different actions within the computing platform 200 or 260, components that determine and/or decide actions to be performed, components that generate reports, components that provide various load balancing or optimization of resources, and so on.

In some implementations, the platform manager module 215 receives information from the decision engine 250, and performs actions based on such information. FIG. 3B depicts components of the decision engine 250. In some implementations, the decision engine 250 includes an information component 360 configured and/or programmed to track, monitor, extract, and/or obtain data and other information from the computing platform 200 or 260. For example, the information component 360 may obtain information associated with a number of users playing a game, a number of game instances providing a game, telematics associated with the game or computing resources providing the game, a current cost to provide a game, and so on.

In some implementations, the decision engine includes a communication component 370 configured and/or programmed to facilitate communication between the decision engine 250 and other components within the computing platform 200 or 260.

In some implementations, the decision engine includes an action performance component 380 configured and/or programmed to perform various actions within the computing platform 200 or 260. For example, the action performance component 380 may cause the manager module 215 to add or remove a game instance based on information obtained by the information component 360.

The decision engine 250 may also include a data storage component 390, such as various databases and/or memory, that store data associated with game play, computing platform resources and/or components, performed actions, data analyses, and so on. The decision engine 250 may also include other components 395, such as components that determine and/or decide actions to be performed, components that generate reports, components that provide various load balancing or optimization of resources, and so on.

Thus, in some implementations, the computing platform 200 or 260 provides a cloud-based gaming environment which provides a layer of abstraction for users of the platform. The abstraction layer, facilitated by a platform manager module 215, enables the computing platform to scale its resources when needed, providing a cost efficient yet powerful computing environment in which to host an online game, such as a massively multi-player online game, among other benefits.

Further details regarding routines and/or techniques performed by resources within the computing platforms 200 and 260, such as routines and/or techniques performed by the platform manager module 215 or the decision engine 250, will now be described.

### Using Cloud-Based Computing Resources to Provide an Online Game

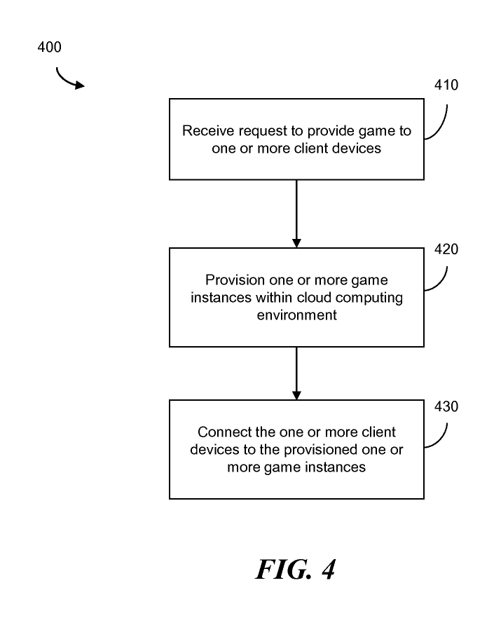

As described herein, in some implementations, the computing platform 200 or 260 facilitates, utilizes, and/or provisions cloud-based resources, such as server instances, to provide and/or support an online game, such as an MMO, to players at client devices within a network. FIG. 4 is a flow diagram illustrating a routine 400 for providing an online game using cloud-based computing resources.

In step 410, the computing platform receives a request from a player to play or otherwise provide an online game to a client device associated with the player. For example, the platform, via the communication component 320 of the platform manager module 215, receives a request from one or more client devices to access an online game supported, or to be supported, by cloud-based computing resources. The client device may transmit the request to the platform manager module 215 via various communication mechanisms, such as the HTTP or other protocols described herein.

In some cases, the request may be initiated by a prospective player loading or accessing a web page or other location that provides the game via a web browser, app, and/or other software supported by the player's client device. In some cases, the request may be initiated by a prospective player accessing a matchmaker service associated with one or more online games.

In step 420, the platform provisions one or more game server instances in response to the received request. For example, the platform, via the instance provisioning component 310 of the platform manager module 215, performs an action to establish, launch, generate, and/or other provision a new and/or additional game instance 212A-C within the cloud-based computing environment 210 that supports the online game.

In some cases, the instance provisioning component 310 accesses one or more exposed APIs associated with available game instances in order to provision a new or additional game instance 212A-C, among other things. In some cases, the instance provisioning component 310 considers various characteristics associated with the requesting client device or devices, such as characteristics associated with a skill level of the player using the client device, the location of the client device, the type of client device, historical information associated with the client device or player, and so on, when provisioning a certain game instance for use with the requesting client device or devices.

In step 430, the platform connects the requesting client device or devices to the provisioned game instance or instances. For example, the platform, via the instance provisioning component 310, facilitates a direct connection between a provisioned game instance 212A and a client device 230.

Thus, the computing platform 200 or 260 receives requests to connect to game servers via an abstraction layer that includes the platform manager module 215, which enables the platform to efficiently and cost-effectively provision cloud-based server instances and other computing resources when providing online games to client devices while facilitating direct connections between requesting client devices and server instances providing the online games, among other benefits.

Managing Game Resources Based on Information from a Matchmaker Service

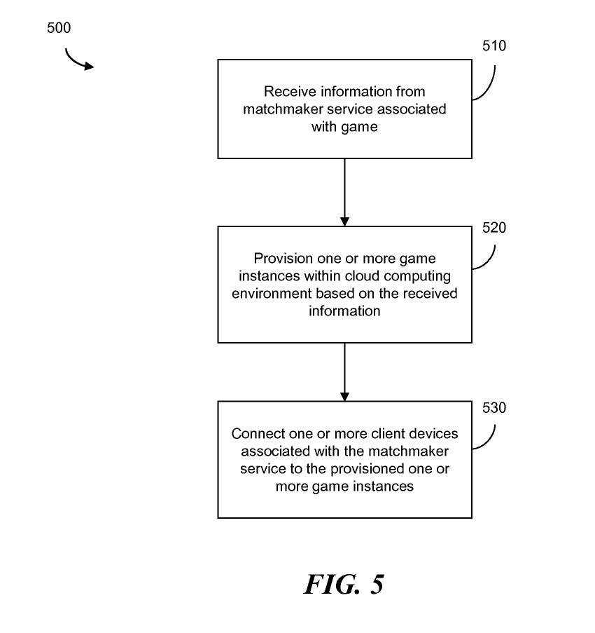

As described herein, in some implementations, the computing platform 200 or 260 utilizes a matchmaker service associated with an online game to provide information about current or predicted resource needs for the online game, and performs actions to manage resources based on such information. FIG. 5 is a flow diagram illustrating a routine 500 for managing computing resources that support an online game based on information received from a matchmaker service associated with the online game.

In step 510, the platform receives information from a matchmaker service associated with an online game. For example, the platform, via the communication component 320 of the platform manager module 215, receives and/or obtains information from a matchmaker service 235 associated with an online game.

In some cases, the information received from the matchmaker service includes information identifying a number of players requesting entry into the online game. In some cases, the information received from the matchmaker service includes biographical information for players request entry into the online game, such as information identifying an age of players, a location of players, a skill level of players, game play statistics, relationships with other players, and so on. In some cases, the information received from the matchmaker service includes information identifying trends or patterns associated with demand or usage of a game, such as information that identifies a likely or predicted increase in players, a likely or predicted decrease in players, a likely or predicted time period for increased or decreased usage, and so on.

In step 520, the platform provisions one or more game server instances in response to the received information. For example, the platform, via the instance provisioning component 310 of the platform manager module 215, performs an action to establish, launch, generate, and/or other provision a new and/or additional game instance 212A-C within the cloud-based computing environment 210 that supports the online game.

In some cases, the instance provisioning component 310 accesses one or more exposed APIs associated with available game instances in order to provision a new or additional game instance 212A-C, among other things. The instance provisioning component 310 may select a game instance to be provisioned based on a variety of factors, including current use of the game instance, cost to use the game instance, location of the game instance, current operation levels of the game instance, and so on.

In step 530, the platform connects a client device or devices associated with players within the matchmaking service o the provisioned game instance or instances. For example, the platform, via the instance provisioning component 310, facilitates a direct connection between a provisioned game instance 212A and a client device 230 associated with a prospective player.

Thus, the computing platform 200 or 260 may obtain and/or receive information from a matchmaker service associated with an online game, and manage supporting resources based on the received information. That is, based on information received from a matchmaker service that indicates a number of players requesting entry into a game and/or information that indicates trends or patterns associated with numbers of players likely to play an online game, a computing platform may stage and/or provide computing resources to meet a predicted or current demand for the online game, among other benefits.

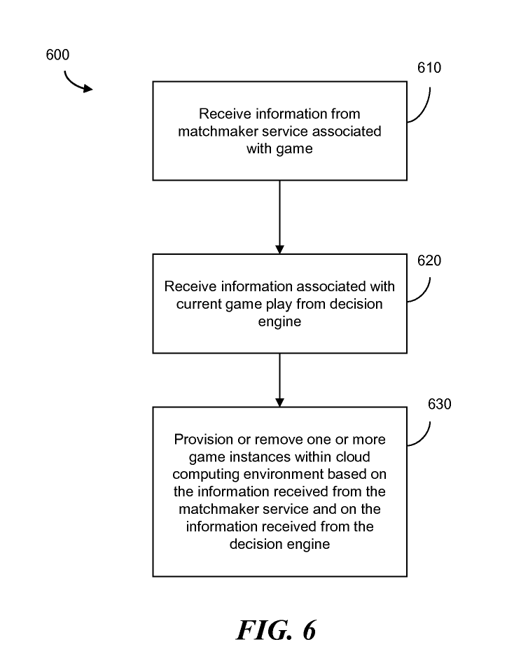

In some implementations, the platform may utilize information obtained from monitoring play of an online game in addition to information received from a matchmaker service when managing computing resources that provide and/or support and online game. FIG. 6 is a flow diagram illustrating a routine 600 for managing computing resources that support an online game based on information received from a matchmaker service associated with the online game and information associated with play of the online game.

Similar to step 510, the platform, in step 610, receives information from a matchmaker service associated with an online game. For example, the platform, via the communication component 320 of the platform manager module 215, receives and/or obtains information from a matchmaker service 235 associated with an online game.

In step 620, the platform receives information associated with play of an online game, such as a currently running online game. For example, the platform, via the communication component 320 of the platform manager module 215, receives and/or obtains information from a decision engine 250 that is monitoring, obtaining information, and performing actions within the computing platform.

In some cases, the information received and/or obtained from the decision engine 250 includes information associated with current, predicted, and/or historical operation of computing resources, information associated with load balancing within the platform, information associated with costs for utilizing the computing resources providing the online game, information associated with locations of resources with respect to locations of players within the online game, and so on.

In step 630, the platform provisions or removes one or more game instances within a cloud computing environment based on the information received from the matchmaker service and on the information received from the decision engine. For example, the platform, via the instance provisioning component 310, performs an action to establish, launch, generate, and/or otherwise provision, or remove, one or more game instances 212A-C within the cloud-based computing environment 210 that supports the online game.

For example, a platform manager that is currently managing an online game averaging 25,000 players per hour obtains information from an associated or affiliated matchmaker service, the information identifying 1,000 new players have registered or checked in with the matchmaker service as well as identifying the new players' skill levels. Based on the number of new players, the platform manager determines that two additional game instances will be required to provide sufficient game operations for the increase in players. The platform manager provisions the two addition game instances, and connects half of the new players associated with a higher level of skill to a first instance, and the remaining new players to the second instance. Once connected, the players begin playing the online game.

### Managing Game Resources Based on Monitoring Game Play or Computing Resources

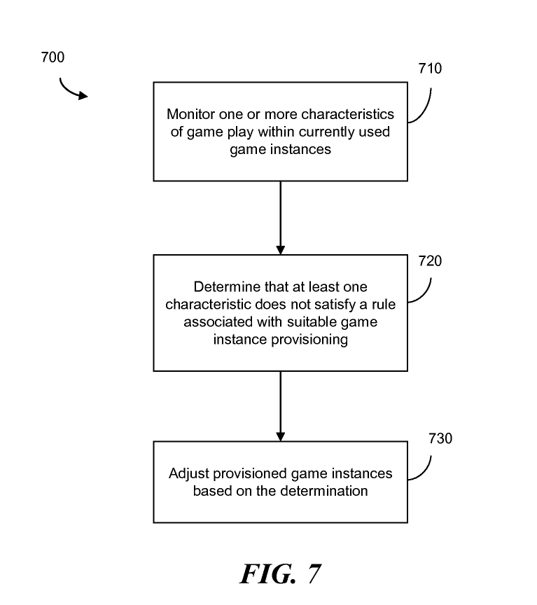

As described herein, in some implementations, the computing platform 200 or 260 manages computing resources based on game play characteristics, such as characteristics associated with allotment of server instances to client devices, among other things. FIG. 7 is a flow diagram illustrating a routine 700 for managing computing resources that support an online game based game play characteristics for the online game.

In step 710, the platform monitors one or more characteristics of game play within currently utilized game instances. For example, the platform, via the monitoring component 330 of the platform manager module 215, monitors or tracks characteristics other information associated with a currently running game. Characteristics that may be monitored may include information associated with current, predicted, and/or historical operation of computing resources, information associated with load balancing within the platform, information associated with costs for utilizing the computing resources providing the online game, information associated with locations of resources with respect to locations of players within the online game, and so on.

In step 720, the platform determines that at least one monitored characteristic does not satisfy a rule associated with suitable game instance provisioning. For example, the platform, via the instance provisioning component 310, compares monitored characteristics and/or values of monitored characteristics to certain criteria, rules, threshold values, and/or other indicators of suitable resource management, and determines whether a current level or utilization of computing resources satisfies these criteria, rules, threshold values, or indicators.

When the platform determines that the monitored characteristics do not indicate suitable resource management levels, the platform, in step 730, adjusts the provisioned game instances accordingly; else maintains the provisioned game instances. For example, the platform, via the instance provisioning component 310, adds one or more instances based on a determination in step 720 that the provisioned game instances cannot satisfactorily support current or predicted levels of game play or players, and removes one or more instances based on a determination in step 720 that one or more provisioned game instances are not required to satisfactorily support current or predicted levels of game play or players.

In some cases, the platform, in step 730, may adjust the provisioned game instances by reallocating or re-provisioning game instances during play of an online game. In some cases, the platform may reallocate, or attempt to reallocate game instances without significantly impacting game play or a game experience for players.

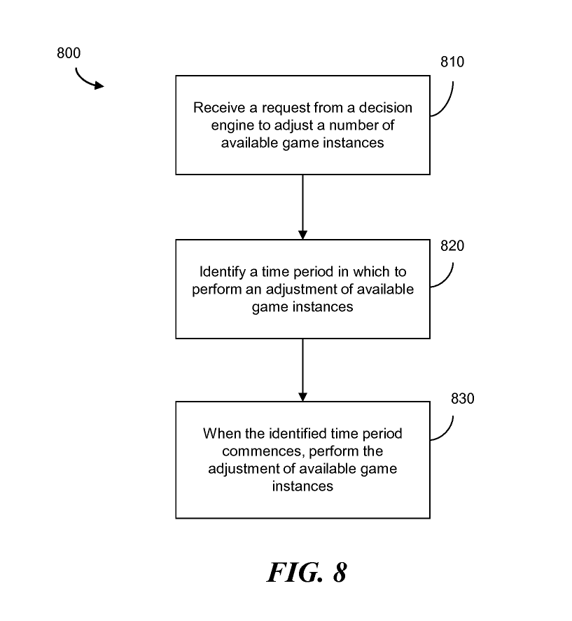

FIG. 8 is a flow diagram illustrating a routine 800 for re-provisioning computing resources that support an online game based on information received from current play within the online game.

In step 810, the platform receives a request to re-provision one or more game instances currently providing and/or supporting an online game to players at client devices. For example, the platform, via the decision engine 250, receives a request at the platform manager module 215 to reallocate players that are currently playing a game to other game instances. The decision engine may do so for a variety of reasons, including reasons associated with balancing the computing load more evenly across computing resources, reasons associated with one or more resources failing or otherwise underperforming, reasons associated with geographically aligning client devices to game instances, reasons associated with game play (e.g., an uneven distribution of players based on skill level), and so on.

In step 820, the platform identifies a time period in which to adjust the provisioned game instances. For example, the platform, via the resource monitoring component 330 of the platform manager module 215 and/or the information component 360 of the decision engine 250, identifies a time period within a currently running game (e.g., a pause between levels of game play) in which re-provisioning game instances will minimally impact game play. Example time periods within a game may include:

+ for role playing games, time periods where a player advances levels, where a score is calculated, where a backstory or other information is being provided, and so on;

+ for 1^{st} person shooter games, time periods where a player advances levels, where a player reloads or otherwise modifies his/her character's capabilities, and so on;

+ for sports games, time periods where there are natural pauses in the game, where a player pauses or otherwise sits out game play, and so on; and so on.

Of course, one or ordinary skill in the art will realize that other time periods may provide suitable occasions in which to re-provision game instances.

When the identified time period commences, the platform, in step 830, performs the adjustment of available game instances. For example, the platform, via the instance provisioning component 310, reallocated players to alternate and/or new game instances, disconnecting the players from the game instances currently providing them the online game and connecting them to other game instances providing the online game.

For example, a cloud-based computing platform is currently supporting an online game to 200,000 worldwide users by utilizing 200 game instances at various locations across the world. Based on historical player usage information received from the decision engine, the computing platform predicts that approximately 40,000 to 50,000 east coast based players will begin playing the game around 8:00 P.M. Eastern Standard Time, while 75,000-80,000 European based players will leave the game around the same time (it being 2:00 A.M. where they live).

Based on the prediction, the platform manager module initiates a process to connect all new east coast based players to newly established server instances located on the east coast, as well as re-allocate any other east coast based players to the newly established server instances, once there is a suitable time period within the online game to make the adjustment. Thus, the platform is able to efficiently move players to other, more ideally located game instances when changes in player demographics occur within the game without disrupting game play and detracting from a player's gaming experience, among other benefits.

Thus, by monitoring game play and other information associated with play of an online game, the layer of abstraction managing an online game supported by the computing platform may facilitate re-provisioning and/or reallocation of server instances and other resources in order to efficiently and cost effectively provide the online game to players, among other benefits.

### CONCLUSION

Thus, in some implementations, the technology described herein provides a publishing platform that enables video game development houses to publish online games without relying on costly capital expenditures for technology infrastructure and complex third-party service integration, while still having enabling a game to scale to 100,000+ concurrent players. From the foregoing, it will be appreciated that specific examples and implementations of the technology have been described herein for purposes of illustration, but that various modifications may be made without deviating from the spirit and scope of the technology. Accordingly, the system is not limited except as by the appended claims.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the technology is not intended to be exhaustive or to limit the system to the precise form disclosed above. While specific embodiments of, and examples for, the technology are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the technology provided herein can be applied to other systems, not necessarily the technology described above. The elements and acts of the various embodiments described above can be combined to provide further embodiments.

These and other changes can be made to the s technology in light of the above Detailed Description. While the above description details certain embodiments of the system and describes the best mode contemplated, no matter how detailed the above appears in text, the system can be practiced in many ways. Details of the technology may vary considerably in implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the technology are presented below in certain claim forms, the inventors contemplate the various aspects of the technology in any number of claim forms. Accordingly, the inventors reserve the right to add additional claims after filing the application to pursue such additional claim forms for other aspects of the technology.

We claim:

1. A cloud-based gaming platform, the platform comprising:
a provisioning component, wherein the provisioning component is configured to provision one or more cloud-based game instances within the gaming environment, the one or more cloud-based game instances providing a game played by client devices that directly communicate with the provisioned one or more cloud-based game instances; and
a determination component, wherein the determination component is configured to determine a certain number of game instances required to provide the game based on information associated with the gaming environment.

2. The platform of claim 1, wherein the determination component is configured to determine a certain number of game instances required to provide the game based on information associated with a number of players within the gaming environment.

3. The platform of claim 1, wherein the determination component is configured to determine a certain number of game instances required to provide the game based on information received from a matchmaker service associated with the gaming environment.

4. The platform of claim 1, wherein the determination component is configured to determine a certain number of game instances required to provide the game based on information associated with usage levels of resources within the gaming environment.

5. A system for providing a cloud-based gaming platform, the system comprising:
one or more cloud-based game instances that provide a game directly to client devices in communication with the game instances; and
an abstraction layer that receives information associated with play of the game and determines a number of the cloud-based game instances in which to provide the game directly to the client devices.

6. The system of claim 5, wherein the abstraction layer receives information from a matchmaker service associated with the game, the information identifying a number of users requesting to play the game; and wherein the abstraction layer determines the number of cloud-based game instances in which to provide the game directly to the client devices based on the number of users requesting to play the game.

7. A gaming platform for providing a massively multiplayer online game (MMO), the platform comprising:
a gaming platform manager, wherein the platform manager includes:
a request component, wherein the request component is configured to receive requests to access the MMO from client devices associated with players of the MMO;
a provisioning component, wherein the provisioning component is configured to provision one or more cloud-based game instances that provide the MMO to the client devices; and
a connection component, wherein the connection component is configured to facilitate direct connections between the client devices and the provisioned cloud-based game instances that provide the MMO.

8. The platform of claim 7, further comprising:
a decision engine, wherein the decision engine is configured to obtain information associated with the MMO and provide the obtained information to the provisioning component;
wherein the provisioning component is further configured to provision a certain number of cloud-based game instances at least in part on the information received from the decision engine.

9. The platform of claim 7, wherein the provisioning component is configured to provision a certain number of cloud-based game instances at least in part on information received from a matchmaker service associated with the MMO.

10. The platform of claim 7, wherein the gaming platform manager is cloud-based.

11. A method performed by a gaming platform for modifying utilization of cloud-based server instances providing an online game to players at client devices, the method comprising:
receiving information from a matchmaker service associated with the online game; and
adding or removing one or more cloud-based server instances providing the online game based on the information.

12. The method of claim 11, wherein the received information indicates a low number of new players for the online game, and wherein adding or removing one or more cloud-based server instances based on the information includes removing at least one cloud-based server instance providing the online game.

13. The method of claim 11, wherein the received information indicates a high number of new players for the online game, and wherein adding or removing one or more cloud-based server instances based on the information includes adding at least one cloud-based server instance providing the online game.

14. The method of claim 11, wherein the received information indicates a low number of predicted new players for the online game, and wherein adding or removing one or more cloud-based server instances based on the information includes removing at least one cloud-based server instance providing the online game.

15. The method of claim 11, wherein the received information indicates a high number of predicted new players for the online game, and wherein adding or removing one or more cloud-based server instances based on the information includes adding at least one cloud-based server instance providing the online game.

16. The method of claim 11, wherein the received information indicates a high number of new players at a certain geographical location for the online game, and wherein adding or removing one or more cloud-based server instances based on the information includes adding at least one cloud-based server instance providing the online game that is proximate to the certain geographical location

17. A system for provisioning cloud-based game instances that provide a massively multi-player online game to client devices, the system comprising:
an information component, wherein the information component is configured to receive information from a matchmaker service that indicates a number of players for the massively multi-player online game;
a provisioning component, wherein the provisioning component is configured to provision one or more cloud-based game instances that provide the massively multi-player online game to client devices based on the indicated number of players within the received information.

18. The system of claim 17, wherein the information component and the provisioning component are located in a cloud-based platform manager module associated with the massively multi-player online game.

19. The system of claim 17, further comprising:
a decision engine, wherein the decision engine is configured to obtain information associated with current play of the massively multi-player online game; and
wherein the provisioning component is further configured to provision the one or more cloud-based game instances that provide the massively multi-player online game to client devices based on the current play information obtained by the decision engine.

20. The system of claim 17, further comprising:
a decision engine, wherein the decision engine is configured to obtain information associated with current costs for providing the massively multi-player online game; and
wherein the provisioning component is further configured to provision the one or more cloud-based game instances that provide the massively multi-player online game to client devices based on the current cost information obtained by the decision engine.

21. A computer-readable storage medium whose contents, if executed by a processor of a computing system that provides a cloud-based gaming environment, cause the processor to perform a method for allocating game instances to client devices associated with players of an online game, the method comprising:
obtaining information from a matchmaker service that indicates a predicted number of players for an online game supported by the cloud-based gaming environment; and
provisioning a certain number of cloud-based game instances that provide the online game to client devices networked to the cloud-based gaming environment based on the obtained information.

22. A method for reallocating one or more cloud-based server instances providing an online game to client devices directly communicating with the server instances, the method comprising:
receiving, at a manager module associated with the online game, information identifying a suboptimal allocation of the one or more cloud-based server instances to client devices affiliated with players of the online game;
identifying a suitable time period within the online game in which to reallocate at least one client device from a first cloud-based server instance to a second cloud-based server instance; and
when the time period commences, performing an action that causes the at least one client device to be reallocated from the first cloud-based server instance to the second cloud-based server instance.

23. A system supported by a platform manager that manages multiple computing resources providing an online game to players at client devices, the system comprising:
a game monitoring component, wherein the game monitoring component is configured to monitor play within the online game and identify a time period suitable for re-provisioning the multiple computing resources with respect to the client devices; and
a re-provisioning component, wherein the re-provisioning component is configured to re-provision at least one client device from a first computing resources to a second computing resource when an identified time period that is suitable for re-provisioning commences.

24. The system of claim 23, wherein the multiple computing resources are cloud-based computing resources.

25. The system of claim 23, wherein the multiple computing resources are game servers.

26. The system of claim 23, wherein the multiple computing resources are cloud-based server instances.

27. A computer-readable storage medium whose contents, if executed by a manager module controlling a computing environment providing an online game via multiple cloud-based game instances to multiple client devices associated with players of the online game, cause the manager module to perform a method for ending use of a first game instance, the method comprising:
receiving information identifying a specific time period within the online game in which to reallocate client devices accessing the online game via the first game instance; and
when the identified specific time period commences within the online game, reallocating the client devices to other game instances providing the online game within the computing environment.

28. The computer-readable storage medium of claim 27, wherein the identified specific time period within the online game is commencement of a specific event within the online game.

29. The computer-readable storage medium of claim 27, wherein the identified specific time period within the online game is a pausing event within the online game.

30. The computer-readable storage medium of claim 27, wherein the identified specific time period within the online game is commencement of a specific event within the online game for a certain number of players playing the online game.

31. The computer-readable storage medium of claim 27, wherein reallocating the client devices to other game instances providing the online game within the computing environment includes reallocating the client devices based on a matching of the geographical locations of the client devices to geographical locations of the other game instances.

32. The computer-readable storage medium of claim 27, wherein reallocating the client devices to other game instances providing the online game within the computing environment includes reallocating the client devices based on a matching of the geographical locations of the client devices to geographical locations of the other game instances and a matching of skill level between players associated with the client devices and players allocated to the other game instances.

33. The computer-readable storage medium of claim 27, wherein reallocating the client devices to other game instances providing the online game within the computing environment includes reallocating the client devices based on a matching of skill level between players associated with the client devices and players allocated to the other game instances.
